(19) United States
(12) Patent Application Publication
(10) Pub. No.: US 2004/0002850 A1
(43) Pub. Date: Jan. 1, 2004

(54) System and method for formulating reasonable spelling variations of a proper name

(76) Inventors: Leonard Arthur Shaefer JR., Ashburn, VA (US); John Christian Hermansen, Catharpin, VA (US); Heather McCallum-Bayliss, McLean, VA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/096,828

(22) Filed: Mar. 14, 2002

(51) Int. Cl. G06F 17/28

(52) U.S. Cl. 704/5

(57) ABSTRACT

A system and method for formulating reasonable spelling variations of name. The system, according to one embodiment, includes a user interface that enables a user to input a name. The system also includes a set of rules (also referred to as “rule set”) and a storage unit that stores a list of names (also referred to as “name database”). The system includes a computer software module (“rules engine”) that implements an algorithm that takes as input the name supplied by the user and the set of rules and, from that input, generates an intermediate representation of the query name, wherein the intermediate representation represents a broad set of possible spelling variations of the name. Next, the system determines the set of names included in the name database that match the intermediate representation. This matching set of names are the names that the system determines to be reasonable spelling variations of the query name.

### BACKGROUND OF THE INVENTION

1. Field of the Invention

The present invention relates generally to information retrieval. More specifically, the present invention concerns a system and method for formulating reasonable spelling variations of a proper name, wherein the formulated spelling variations may be used by a user who is attempting to retrieve from a database information that is associated with the proper name.

2. Discussion of the Background

A database is collection of information organized in such a way that a computer program can quickly and easily select desired pieces of data. A database typically includes a number of records, and each record includes one or more fields. Each field typically stores a single piece of information.

In such databases, retrieval of records that are associated with a person typically involves use of a unique identifying value or “key,” such as an ID number. For certain retrieval tasks, a unique identifying value is not always available, and the person's name itself must be used as the identifying value or “key”.

However, personal names have several limitations inhibiting their effectiveness as identifying values for retrieval of information from a database. For example, personal names are not unique. Numerous individuals may possess names with some or even all elements in common with many other individuals. In extreme cases, the same name may be commonly used by thousands or even millions of different people. Conversely, people who are closely related sometimes exhibit significant differences in the way each spells a commonly held family name. Moreover, a specific person may be represented in many different records within a database, and that person's name may be rendered in slightly or greatly differing forms within those database records.

Additionally, names are not used consistently. Within the U.S. society, as indeed in most societies around the world, individuals are permitted a certain degree of latitude in determining the form of name they provide, orally or in writing, when providing information that is subsequently placed in a database.

Furthermore, names change over time. Names are social objects that are used to record various kinds of information, so they can be modified in various ways as time passes, in order to reflect changes in social or personal status by the bearer. In many Western societies, for example, names may change over time in order to reflect changes in marital status, educational or professional achievements, or even gender affiliation.

Yet another drawback of using personal names as a database key is that names are not consistently captured. Because it is more difficult to validate the spelling of names than it is to validate the spelling of most other words in a particular language, name information in a database is correspondingly subject to a greater incidence of spelling and keying errors.

Because of both the inherent variability and ubiquity of names, especially in very large databases, it is important to know when a name may be commonly spelled in a variety of ways, so that database information that may not be retrieved under one spelling may be successfully located and retrieved under one or another of the other spellings typically associated with the name originally supplied, when the name is used, alone or in combination with other fields, as the basis for a retrieval request.

### SUMMARY OF THE INVENTION

The present invention provides a system and method for formulating reasonable spelling variations of proper names, such as personal names and other proper names.

In one aspect, the system, according to one embodiment, includes a user interface that enables a user to input a name into the system. The system also includes a set of rules (also referred to as “rule set”) and a storage unit that stores a list of names (also referred to as “name database”). The system further includes a computer software module that implements an algorithm that takes as input the name supplied by the user (the “query name” (QN)) and the set of rules and, from that input, generates an intermediate representation of the query name, wherein the intermediate representation represents a broad set of possible spelling variations of the query name. Next, the system determines the set of names included in the name database that match the intermediate representation. This matching set of names represents the names that the system determines to be reasonable spelling variations of the query name. The system is operable to output (e.g., display or transmit) the names that are determined to be a reasonable spelling variation of the query name. Advantageously, the system is operable to rank each name in the set such that a name in the set with a higher ranking than another name in the set is set forth as a more commonly encountered or statistically more frequently observed spelled form of the query name.

In one embodiment, the intermediate representation is a regular expression (RE) that represents in a concise and mathematically rigorous form a set of possible spelling variations of the query name. The system, after generating the regular expression, uses conventional pattern-matching and string-matching technology to determine the set of names in the name database that match the regular expression. This set of names is determined to comprise reasonable spelling variations of the query name.

In another embodiment, the intermediate representation comprises one or more character strings, wherein each character string is a possible spelling variation of the query name. For each generated character string, the system determines whether the generated string is included in the name database. If a generated character string is included in the name database, then the character string is considered a reasonable spelling variation of the query name.

In another embodiment, the intermediate representation comprises a character string of phonetic symbols, wherein the character string represents a set of plausible pronunciations of the query name. The system determines the set of names included in the name database that have a pronunciation equivalent to or closely similar to the pronunciation of the of the query name. In this embodiment, each name in the name database is preferably associated with one or more character stings of phonetic symbols, wherein each character string represents a set of plausible pronunciations of the name with which it is associated. And the system determines whether a name in the name database (a “considered name”) has a pronunciation that is either equivalent to or closely similar to the pronunciation of the query name by determining whether the generated character string matches any of the character strings associated with the considered name. In the instance of equivalently matching names in the name database, the system determines that there is at least one possible pronunciation common both to the query name and the considered name. In the instance of similarly matching names, the system determines that there is at least one possible pronunciation for the considered name that falls within a desired scope of phonological proximity to the query name, as calculated by the system.

Preferably, the system includes more than one rule set. More specifically, in one particular embodiment, the system includes a default rule set and one or more additional rule sets, wherein each additional rule set is associated with names originating in a particular cultural or ethnic community, to include its associated language(s), corresponding orthographic (writing) system(s) and social conventions affecting the nature and use of names within that community. In this embodiment, the system further includes a name classifier that determines whether or not the query name can reasonably be expected to have originated in a culture with which a rule set is uniquely associated. If the name appears to belong to a culture with which a rule set is associated, then the system applies that rule set to generate the intermediate representation of the query name. If the query name does not appear to belong to a culture with which a rule set is associated, then the system applies the default rule set to generate the intermediate representation of the query name.

The above and other features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 is a functional block diagram of a system, according to an embodiment of the present invention, for formulating reasonable spelling variations of a name.

FIG. 2 is a functional block diagram of a system, according to another embodiment of the present invention, for formulating reasonable spelling variations of a name.

FIG. 3 illustrates an example linguistic rule.

FIG. 4 is a functional block diagram of a system, according to another embodiment of the present invention, for formulating reasonable spelling variations of a name.

FIG. 5 is a flow chart illustrating a process, according to one embodiment, for formulating reasonable spelling variations of a name.

FIG. 6 is a flow chart illustrating a process, according to one embodiment, for formulating possible spelling variations of a name.

### DETAILED DESCRIPTION OF EMBODIMENTS OF THE INVENTION

While the present invention may be embodied in many different forms, there is described herein in detail an illustrative embodiment with the understanding that the present disclosure is to be considered as an example of the principles of the invention and is not intended to limit the invention to the illustrated embodiment.

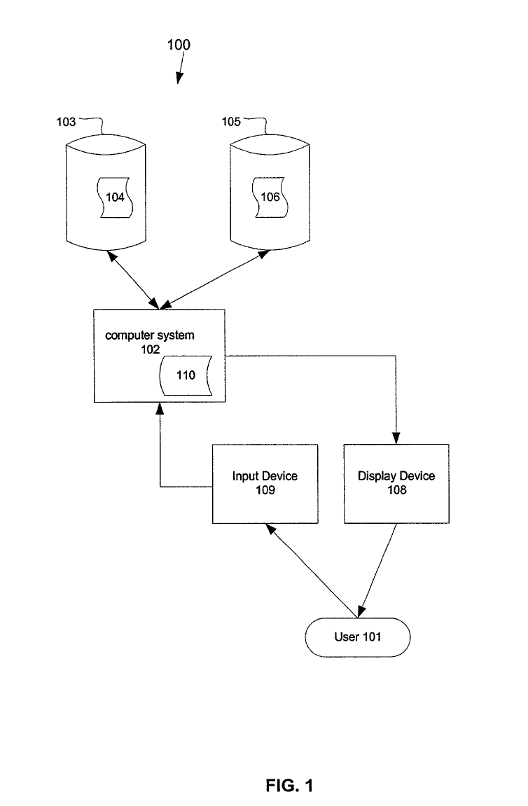

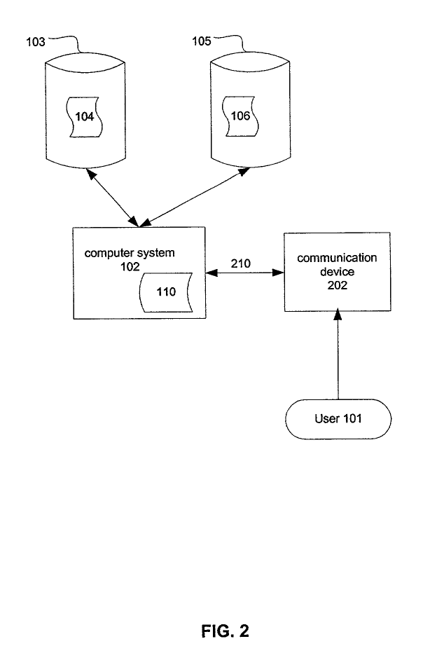

FIG. 1 is a functional block diagram of a system 100, according to an embodiment of the present invention, for formulating reasonable spelling variations of a name (e.g., a personal name). System 100 includes a computer system 102, a storage device 103 for storing a name database 104 that stores a set of names, a storage device 105 for storing a rule set 106 that includes a set of rules, a display device 108 for displaying information to a user 101, and an input device 109 (e.g., keyboard, mouse, and/or other input device) that enables system 102 to receive input from user 101. Although storage device 103 and storage device 105 are shown as being separate, it is contemplated that a single storage device could be used to store both the name database 104 and rule set 106. Computer system 102 further includes software 110 that enables computer system 102 to provide the features described herein. Software 110 comprises one or more software modules. User 101 may interact with computer system 102 directly as shown in FIG. 1 or, as shown in FIG. 2, user 101 may interact with computer system 102 indirectly by using a communication device 202 and a network 210. Communication device 202 can by any device capable of sending data to and receiving data from computer system 202. For example, device 202 may be a personal computer, mobile telephone, personal digital assistant (PDA), or other device capable of transmitting and receiving data.

When system 102 executes software 110, system 102 is operable to: (a) enable user 101 to input a name into system 102, (b) formulate reasonable spelling variations of the query name based on the rule set 106 and the name database 104, and (c) output the reasonable spelling variations.

Preferably, name database 104 includes a set of given names and a set of surnames. In one embodiment, each name in database 104 is associated with a frequency number that represents the frequency of the name's occurrence. For example, the surname “Smith” may be associated with a frequency number of 15,000 whereas the surname “Smythe” may be associated with a frequency number of 1,200. Each name may also be associated with information concerning the name's correlation with gender (i.e., is the name a “female” or “male” name), culture, and country of origin of the name's bearer, as assembled from a variety of public sources. This name information may be stored in database 104. It is also preferred that name database 104 contain a large number of names (e.g., several million unique entries works well) so that the coverage of the system is broad enough for practical effectiveness in typical commercial setups.

In one embodiment, rule set 106 includes linguistic rules that specify linguistic spelling variations. For example, rule set 106 may include linguistic rules that specify linguistic spelling variations that are anticipated for names of Russian or Slavic origin. One such rule, for example, may specify that the strings (i.e., letter sequences) TCH, TSCH, and CH may be considered equivalent when found in the “initial” (left-most) portion of a Russian surname and when followed immediately by any of the characters in the set of Russian vowels. The practical effect of such a rule is to allow a query name, such as TCHAIKOVSKY, to render an intermediate representation sufficient to match the spelling CHAIKOFSKY in the name database, thereby alerting the user to the availability of a less frequent spelling for the query name.

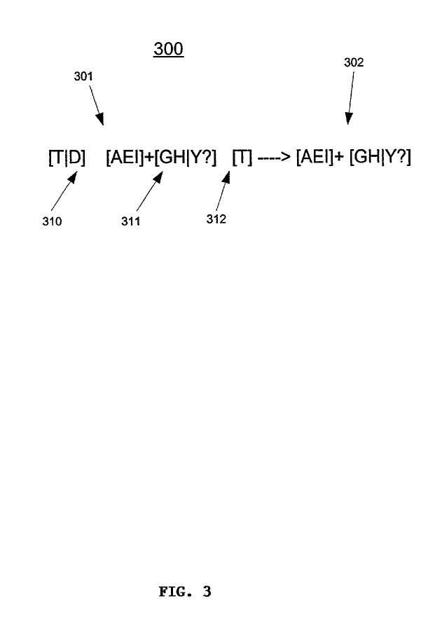

To illustrate the format of the rules in rule set 106, FIG. 3 shows an example rule 300. As shown in FIG. 3, rule 300 includes a first pattern 301 and a second pattern 302. First pattern 301 includes three parts: a beginning portion 310, a middle portion 311 and an end portion 312. Other rule formats may be used as the invention is not intended to be limited to any particular rule format. If a character string matches first pattern 301, then the portion of the character string that matches the middle portion 311 of pattern 301 may be replaced with the second pattern 302. For example, according to rule 300, the string “AY” in the query name “DAYTON” can be rendered as the regular expression “[AEI]+[GH|Y?]” which, among others, yields the following possible spelling variations for DAYTON: DATON, DEIGHTON, DEATON, DAITON, DEITON, etc.

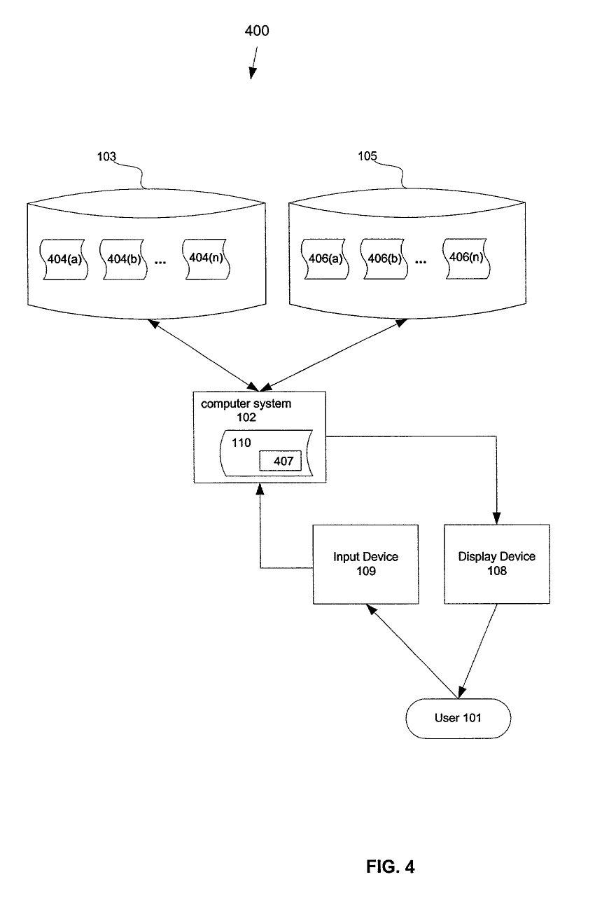

FIG. 4 illustrates a preferred embodiment of the present invention. In this embodiment, system 100 includes a default rule set 406(a), one or more additional rule sets 406(b), 406(c), . . . , 406(n), a default name database 404(a), on or more additional name databases 404(b), 404(c) . . . 404(n), and a name classifier software module 407. Each rule set 406(b)-(n) and each name database 404(b)-(n) is associated with a particular culture. For example, rule set 406(b) and name database 404(b) may be associated with the Russian culture, whereas rule set 406(c) and name database 404(c) may be associated with the Arabic culture. Name classifier 407 functions to determine whether or not the query name appears to belong to a culture with which a rule set 406 and a name database 404 are associated. Co-pending U.S. patent application Ser. No. 09/275,766, filed on Mar. 25, 1999, which is assigned to the assignee of the present invention and which is incorporated herein by this reference, describes a name classifier algorithm that can be used to implement name classifier 407.

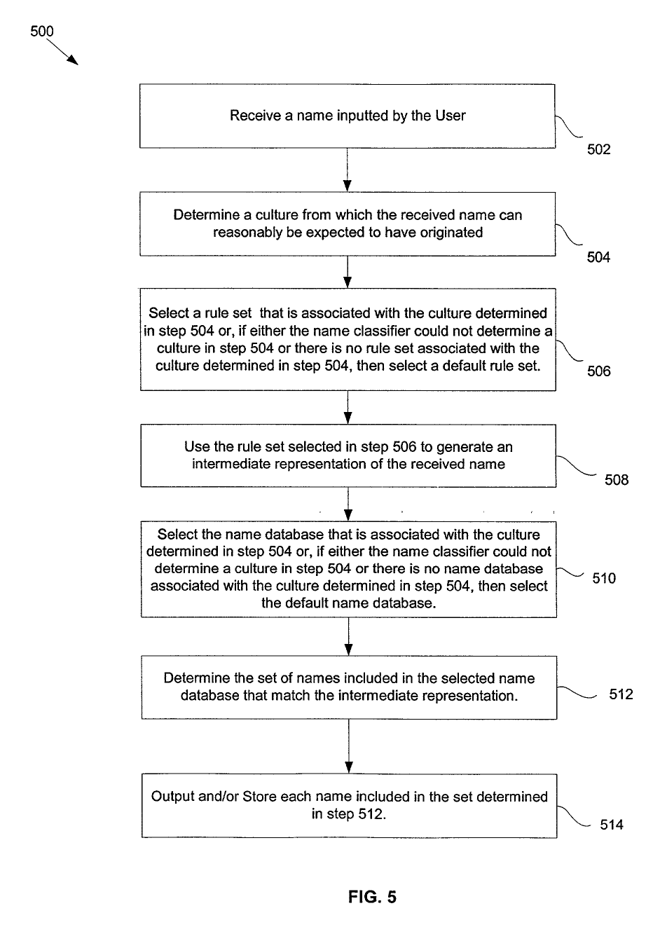

FIG. 5 is a flow chart illustrating a process 500 performed by one embodiment of software 110 for formulating the reasonable spelling variations of a name. Process 500 begins in step 502, where software 110 receives a name supplied by user 101. Next (step 504), name classifier module 570 determines a culture from which the query name can reasonably be expected to have originated. Next (step 506), software 110 selects the rule set 406 that is associated with the culture determined in step 504 or selects default rule set 406(a) if either the name classifier could not determine a culture in step 504 or there is no rule set 406 associated with the culture determined in step 504.

Next (step 508), software 110 uses the rule set 406 selected in step 506 to generate an intermediate representation of the query name, wherein the intermediate representation comprises a set of plausible spelling variations associated with the query name, as defined by the linguistic rules included in the rule set 406 selected in step 506. Next (step 510), software 110 selects the name database 404 that is associated with the culture determined in step 504 or selects default name database 404(a) if either the name classifier could not determine a culture in step 504 or there is no name database 404 associated with the culture determined in step 504.

Next (step 512), software 110 determines the set of names included in the selected name database 404 that match the intermediate representation. More specifically, if the query name is a given name, software 110 determines all of the names included in the name database's given name list that match the intermediate representation, and if the query name is a surname, software 110 determines all of the names included in the name database's surname list that match the intermediate representation. The matching set of names are the names that the system determines to be reasonable spelling variations of the query name.

Next (step 514), software 110 outputs and/or stores each name included in the set determined in step 512. Preferably, software 110 also outputs the frequency number associated with each outputted name so that one receiving the output can determine the names that have the highest frequency of use.

In one embodiment, the intermediate representation generated in step 508 is a regular expression (RE) that represents in a concise and mathematically rigorous form a set of possible spelling variations of the query name. After generating the RE, software 110 accesses the selected name database and selects just those names from the selected name database which fully match the RE generated in step 508. This set of names comprises reasonable spelling variations of the query name.

In another embodiment, the intermediate representation comprises one or more character strings, wherein each character string is a possible spelling variation of the query name. For each generated character string, software determines whether the generated string is included in the selected name database. If a generated character string is included in the selected name database, then the character string is considered a reasonable spelling variation of the query name.

In still another embodiment, the intermediate representation comprises a character string of phonetic symbols, wherein the character string represents a pronunciation of the query name. Software determines the set of names included in the selected name database that have a pronunciation equivalent to the pronunciation of the of the query name. In this embodiment, each name in the name database is preferably associated with one or more character stings of phonetic symbols, and software 110 determines whether a name in the name database has a pronunciation that is either equivalent to or adequately similar to the pronunciation of the query name by determining whether the generated character string matches any of the character strings associated with the name in the name database.

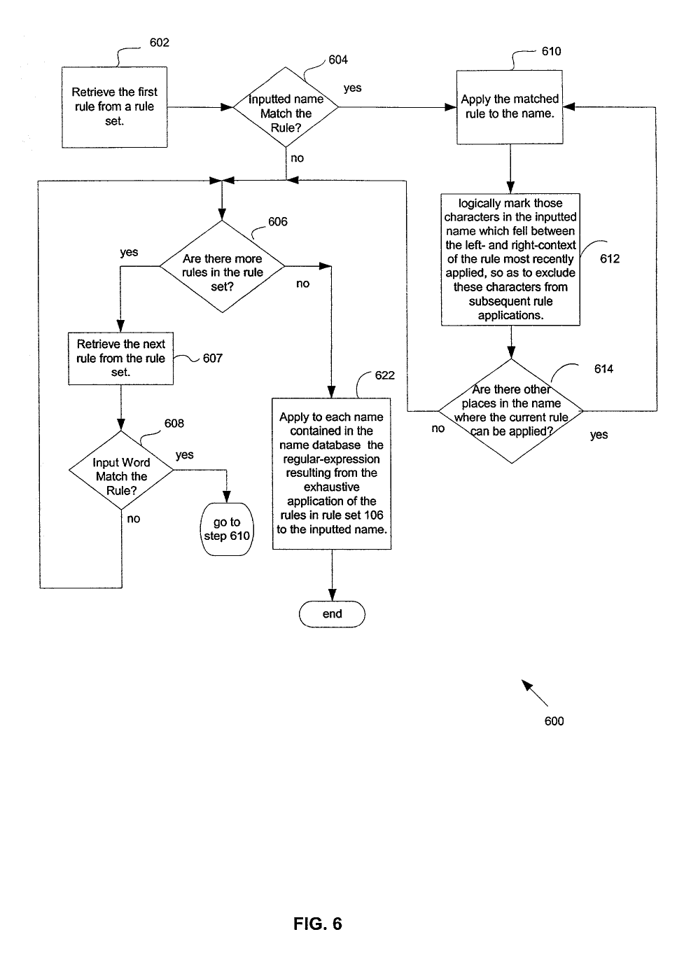

FIG. 6 is a flow chart illustrating a process 600 that may be performed by software 110 in generating an RE that represents in a concise and mathematically rigorous form a set of possible spelling variations of the query name. Process 600 begins in step 602, where software 110 retrieves the first rule from rule set 106. Next (step 604), software 110 compares the query name to the first rule to determine if the name matches the first rule. If the query name matches the first rule, then control passes to step 610, otherwise control passes to step 606.

In step 606, software 110 determines if the end of the rule set has been reached. If the end of the rule set is reached, control passes to step 622; otherwise, control passes to step 607. In step 607, software 110 retrieves the next rule from rule set 106. Next (step 608), software 110 compares the name to the next rule retrieved in step 607 to determine if the name matches the rule. If the name does not match the this rule, then control passes back to step 606; otherwise, control passes to step 610.

In step 610, software 110 applies the matched rule to the name. Rule application consists of identifying the boundaries of the rule left-context and right-context, then substituting a regular expression for that portion of the query name which is determined to lie between the left-context and the right-context of the matched rule. For example, if we assume that rule set 106 includes the rule {[T|D],[AEI]+[GH|Y?],[T]→[AEI]+[GH|Y?]}, and if the query name is DAYTON, then, the first time step 610 is executed, software 110 will match the DAYT portion of the name, set the left-context as [D], set the right-context as [T], set the portion between the left- and right-context as [AY], and replace [AY] with the regular-expression [AEI]+[GH|Y?]. The net effect of this substitution is to render a regular-expression from DAYTON as follows: D([AEI]+[GH|Y?])TON. This RE allows subsequent identification of names such as DATON, DEIGHTON, DEATON, DAITON and DEITON, inter alia, as plausible spelling variants for DAYTON, provided that each of the latter names is found in name database 104. After step 610, control passes to step 612.

In step 612, software 110 logically marks those characters in the query name which fell between the left- and right-context of the rule most recently applied, so as to exclude these characters from subsequent rule applications. In step 613, software 110 determines whether the end of the query name has been reached. That is, software 110 determines whether there are any other places in the query name where the current rule can be applied. If there are, control passes to step 610; otherwise, control passes to step 606.

In step 622, software 110 applies to each successive name contained in name database 104 the regular-expression resulting from the exhaustive application of the rules in rule set 106 to the query name. Only names from the same culture as that defined for the query name and from the same portion of the name (surname or given-name) as the query name are considered during this matching operation by software 110. When a valid match is determined by software 110, then the matched name from name database 104 and its associated frequency of occurrence or “count” are stored by software 110.

While the processes illustrated herein may be described as a series of consecutive steps, none of these processes are limited to any particular order of the described steps. Additionally, it should be understood that the various illustrative embodiments of the present invention described above have been presented by way of example only, and not limitation. Thus, the breadth and scope of the present invention should not be limited by any of the above-described exemplary embodiments, but should be defined only in accordance with the following claims and their equivalents.

What is claimed is:

1. A method for formulating reasonable spelling variations of a name, comprising the steps of:
receiving a name;
generating one or more character strings based on the received name and linguistic rules included in a rule set, wherein each character string is a possible spelling variation of the received name;
accessing a name database; and
for each generated character string, determining whether the generated string is included in the name database; and
outputting the generated character strings that are determined to be included in the name database.

2. The method of claim 1, wherein the received name comprises a given name and/or a surname.

3. The method of claim 2, further comprising the step of storing at least two rule sets, wherein each of the at least two rule sets is associated with a particular culture.

4. The method of claim 3, further comprising the step of determining whether the input name appears to belong to a culture with which one of the at least two rule sets is associated.

5. The method of claim 4, wherein if the input names appears to belong to a culture with which one of the at least two rule sets is associated, the method further comprises the step of selecting the rule set that is associated with the culture to which the input name appears to belong and using the selected rule set to generate the one or more character strings.

6. The method of claim 1, wherein the name database includes more than one million names.

7. The method of claim 1, wherein the rule set comprises a plurality of rules and wherein the input name comprises a string of characters.

8. The method of claim 7, wherein each of the plurality of rules includes a first pattern and a second pattern, and wherein each first pattern includes a defined beginning portion, middle portion, and end portion.

9. The method of claim 8, wherein the step of generating the one or more character strings comprises the steps of:
selecting a rule from the rule set;
determining whether the input name matches the selected rule's first pattern, wherein if the input name matches the selected rule's first pattern, then the input name comprises a string of characters that matches the defined middle portion of the selected rule's first pattern; and
if the input name matches the selected rule's first pattern, then generating a character string by combining the selected rule's second pattern with the zero or more characters included in the input name that precede said character string that matches the defined middle portion of the first pattern.

10. A method for formulating reasonable spelling variations of a name, comprising the steps of:
receiving a name;
generating a regular expression based on the received name and one or more rules included in a rule set, wherein the regular expression represents a set of possible spelling variations of the received name;
determining the set of names included in a name database that match the generated regular expression; and
outputting each name from the name database that is determined to match the generated regular expression.

11. The method of claim 10, further comprising the step of storing at least two rule sets, wherein each of the at least two rule sets is associated with a particular culture.

12. The method of claim 11, further comprising the step of determining whether the received name appears to belong to a culture with which one of the at least two rule sets is associated.

13. The method of claim 12, wherein if the received name appears to belong to a culture with which one of the at least two rule sets is associated, the method further comprises the step of selecting the rule set that is associated with the culture to which the received name appears to belong and using the selected rule set to generate the regular expression.

14. The method of claim 10, wherein the name database includes more than a million names.

15. The method of claim 10, wherein the rule set comprises a plurality of rules and wherein the received name comprises a string of characters.

16. The method of claim 15, wherein each of the plurality of rules includes a first pattern and a second pattern, and wherein each first pattern includes a defined beginning portion, middle portion, and end portion.

17. The method of claim 16, wherein the step of generating the regular expression comprises the steps of:
selecting a rule from the rule set;
determining whether the received name matches the selected rule's first pattern, wherein if the received name matches the selected rule's first pattern, then the received name comprises a string of characters that matches the defined middle portion of the selected rule's first pattern; and
if the received name matches the selected rule's first pattern, then generating a regular expression by combining the selected rule's second pattern with the zero or more characters included in the received name that precede said character string that matches the defined middle portion of the first pattern.

18. A system for formulating reasonable spelling variations of a name, comprising:
receiving means for receiving a name;
generating means for generating one or more character strings based on the received name and rules included in a rule set, wherein each character string is a possible spelling variation of the received name;
accessing means for accessing a name database;
determining means for determining whether a generated string is included in the name database; and
means for outputting the generated character strings that are determined to be included in the name database.

19. The system of claim 18, further comprising means for storing at least two rule sets, wherein each of the at least two rule sets is associated with a particular culture.

20. The system of claim 19, further comprising means for determining whether the received name appears to belong to a culture with which one of the at least two rule sets is associated.

21. The system of claim 20, wherein if the received names appears to belong to a culture with which one of the at least two rule sets is associated, the generating means selects the rule set that is associated with the culture to which the received name appears to belong and uses the selected rule set in generating the one or more character strings.

22. The system of claim 18, wherein the name database includes more than one million names.

23. The system of claim 18, wherein the rule set comprises a plurality of rules and wherein the received name comprises a string of characters.

24. The system of claim 23, wherein each of the plurality of rules includes a first pattern and a second pattern, and wherein each first pattern includes a defined beginning portion, middle portion, and end portion.

25. The system of claim 24, wherein the generating means comprises:
means for selecting a rule from the rule set;
means for determining whether the received name matches the selected rule's first pattern, wherein if the received name matches the selected rule's first pattern, then the received name comprises a string of characters that matches the defined middle portion of the selected rule's first pattern; and
means for combining the selected rule's second pattern with the zero or more characters included in the received name that precede said character string that matches the defined middle portion of the first pattern if the received name matches the selected rule's first pattern.

26. A system for formulating reasonable spelling variations of a name, comprising:
receiving means for receiving a name;
generating means for generating a regular expression based on the received name and one or more rules included in a rule set, wherein the regular expression represents a set of possible spelling variations of the received name;
determining means for determining the set of names included in a name database that match the generated regular expression; and
outputting each name from the name database that is determined to match the generated regular expression.

27. The system of claim 26, further comprising means for storing at least two rule sets, wherein each of the at least two rule sets is associated with a particular culture.

28. The system of claim 27, further comprising means for determining whether the received name appears to belong to a culture with which one of the at least two rule sets is associated.

29. The system of claim 28, wherein if the received names appears to belong to a culture with which one of the at least two rule sets is associated, the generating means selects the rule set that is associated with the culture to which the received name appears to belong and uses the selected rule set in generating the regular expression.

30. The system of claim 26, wherein the name database includes more than one million names.

31. The system of claim 26, wherein the rule set comprises a plurality of rules and wherein the received name comprises a string of characters.

32. The system of claim 31, wherein each of the plurality of rules includes a first pattern and a second pattern, and wherein each first pattern includes a defined beginning portion, middle portion, and end portion.

33. The system of claim 32, wherein the generating means comprises:
means for selecting a rule from the rule set;
means for determining whether the received name matches the selected rule's first pattern, wherein if the received name matches the selected rule's first pattern, then the received name comprises a string of characters that matches the defined middle portion of the selected rule's first pattern; and
means for combining the selected rule's second pattern with the zero or more characters included in the received name that precede said character string that matches the defined middle portion of the first pattern if the received name matches the selected rule's first pattern.
